(19) United States
(12) Patent Application Publication
(10) Pub. No.: US 2015/0292482 A1
(43) Pub. Date: Oct. 15, 2015

(54) TURBINE WITH CAM-DRIVEN VARIABLE ORIENTATION POWER SAILS

(71) Applicant: Mukund Manohar Sheorey, Kingman, AZ (US)

(72) Inventor: Mukund Manohar Sheorey, Kingman, AZ (US)

(21) Appl. No.: 14/687,863

(22) Filed: Apr. 15, 2015

Related U.S. Application Data
(60) Provisional application No. 61/979,610, filed on Apr. 15, 2014.

(51) Int. Cl. F03D 3/06; F03D 11/00; F03D 3/00

(52) U.S. Cl. CPC F03D 3/068; F03D 3/005; F03D 11/0008

(57) ABSTRACT

A wind turbine includes a cam track system that catches fluid flow in optimum flow and removes a sail from the direction of rotation in response to the sail being out of the fluid flow. The wind turbine may be a vertical axis wind turbine. A wind vane assembly may turn the cam track to align cam a bearing in the track to the direction of fluid flow. A sail assembly connected to the cam bearing may ascend/descend in the track to catch fluid flow and tilt flat when out of fluid flow.

### CROSS-REFERENCE TO RELATED APPLICATIONS

This application claims benefit under 35 U.S.C. §119(e) of U.S. Provisional Application having Ser. No. 61/979,610 filed Apr. 15, 2014, which is hereby incorporated by reference herein in its entirety.

### BACKGROUND

The embodiments herein relate generally to wind turbines, and more particularly, to a wind turbine with a vane system on a cam track.

Current turbine designs have a relatively low Return on Investment (ROI). This is because of their relatively high cost and low efficiency. For example, some conventional wind turbines typically operate with impellers turning a static axis. In a variation, some turbines rotate the impellers along axles so that impellers on the windward side of fluid flow are aligned to present maximum aerodynamic resistance to fluid flow and impellers on the leeward side of fluid flow are aligned to present minimum aerodynamic resistance. The windward and leeward impellers still rotate around a single plane. As may be appreciated, Betz law limits the amount of fluid flow through conventional wind turbines.

As can be seen, there is a need for a turbine that dramatically reduces manufacturing costs and provides increased efficiency.

### SUMMARY

According to one embodiment of the present invention, a wind turbine comprises a turbine shaft; a cam bearing track positioned radially around the turbine shaft, the track including a lower section, an upper section, and a sloped section connecting the lower section to the upper section; a groove along an outer perimeter of the track; a cam bearing configured to move within the groove; an arm coupled to the cam bearing, the arm projecting axially away from the turbine shaft; and a sail coupled to the arm.

### BRIEF DESCRIPTION OF THE FIGURES

The detailed description of some embodiments of the present invention is made below with reference to the accompanying figures, wherein like numerals represent corresponding parts of the figures.

FIG. 1 is a perspective view of a wind turbine in accordance with an exemplary embodiment of the subject technology;

FIG. 2 is a perspective view of the wind turbine of FIG. 1 in use;

FIG. 3 is an enlarged, perspective view of a cam track of the wind turbine of FIG. 1;

FIG. 4 is partial side view of the wind turbine of FIG. 1;

FIG. 5 is a side view of a vane of the wind turbine of FIG. 1;

FIG. 6 is an enlarged partial view of a cam to support bracket connect for a sail of the wind turbine of FIG. 1;

FIG. 7 is an enlarged, perspective partial view of a cam track to sail connection of the wind turbine of FIG. 1;

FIG. 8 is a magnified view of the connection of FIG. 7 with the sail in an un-tiled angle within fluid flow;

FIG. 9 is a magnified view of the connection of FIG. 7 with the sail in a partially tilted angle within fluid flow.

FIG. 10 is a magnified view of the connection of FIG. 7 with the sail fully tilted perpendicular to fluid flow.

FIG. 11 is a partial side view of a wind turbine employing a plurality of sails from one support arm in accordance with an alternate embodiment of the subject technology.

### DETAILED DESCRIPTION OF CERTAIN EMBODIMENTS

The word “exemplary” is used herein to mean “serving as an example or illustration.” Any aspect or design described herein as “exemplary” is not necessarily to be construed as preferred or advantageous over other aspects or designs.

Broadly embodiments of the disclosed subject matter provide a wind turbine using a cam system and rotating sails which work together to turn the sails in sync with the wind direction such that the sails generate a torque downwind while presenting almost no drag upwind. Manufacturing cost is dramatically reduced and efficiency is greatly increased by overcoming many of the limits on efficiency predicted by Betz Law.

Referring now to the Figures, a wind turbine 100 is shown in accordance with an exemplary embodiment of the subject technology. In an exemplary embodiment, the wind turbine is a vertical axis wind turbine, for example, a Savonius type turbine. The wind turbine includes power sail assemblies 10, a cam assembly 55 (including a track system 50 a cam bearing 52), a turbine shaft 44, and a vane sail assembly 22. In general, the vane sail assembly 22 aligns the cam assembly with fluid flow (for example wind direction). Alignment of the cam assembly 55 may be for example, pulling/pushing the cam bearing 52 within the track system 50 into a position perpendicular to fluid flow. The cam assembly 55 may in response move sail assemblies 10 into a position perpendicular to fluid flow for optimum transference of fluid flow energy from the sail assemblies 10 to the turbine shaft 44.

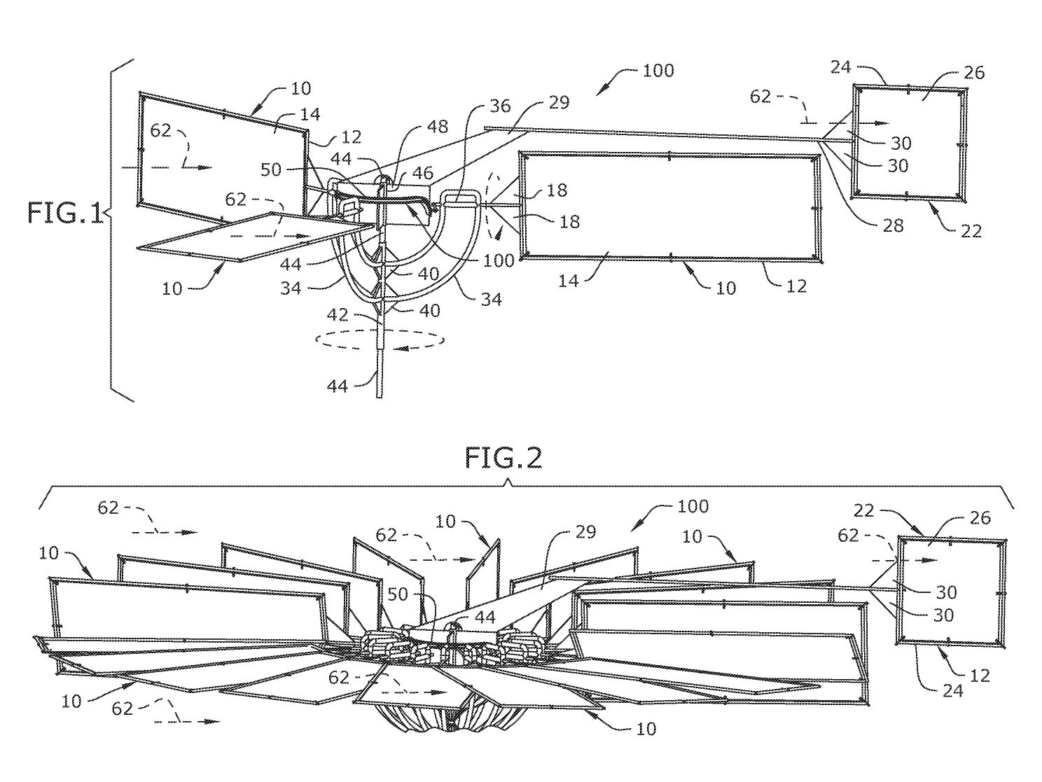

Referring to FIGS. 1 and 2, the wind turbine 100 is shown in a static position (FIG. 1) and in an illustration showing movement of three power sail assemblies 10 from flat positions to positions perpendicular to fluid flow (FIG. 2) however it will be understood that some embodiments may use more or less than three sails. The turbine shaft 44 is coupled to a rotor tube 42 for turning and generating electrical energy as is known in the art. The cam assembly 55 may be connected to the turbine shaft 44 by a cam tube 46. A plurality of support brackets 34 (for example, one for each power sail assembly 10) may be connected to the rotor tube 42 by support bracket gussets 40. The brackets 34 may be substantially “U”-shaped including for example a lower shaft originating from a lower gusset 40 and upper shaft originating from an upper gusset 40, the lower and upper shafts joined at their ends by a cross connecting member. A connecting member 29 connects the vane sail assembly 22 to the cam track system 50. The power sail assembly 10 may include a panel 14 held by a rectangular frame 12. The panel 14 may be a flexible fabric panel or a rigid material. The frame 12 may include gussets 18 connected to an arm 16 (FIG. 4). The vane sail assembly 22 may include a wind interfacing panel 26 held by a rectangular frame 24 and gussets 30. The panel 26 may be held to the frame 24 by flexible cords 32 (FIG. 5). The frame 24 may be connected to the cam assembly via a shaft 28. As shown, arrows 62 represent wind force vectors. Power sail assemblies 10 positioned perpendicular to gravity (lying flat) are not in fluid flow. Power sail assemblies 10 tilted or aligned with gravity (vertical) are catching fluid flow.

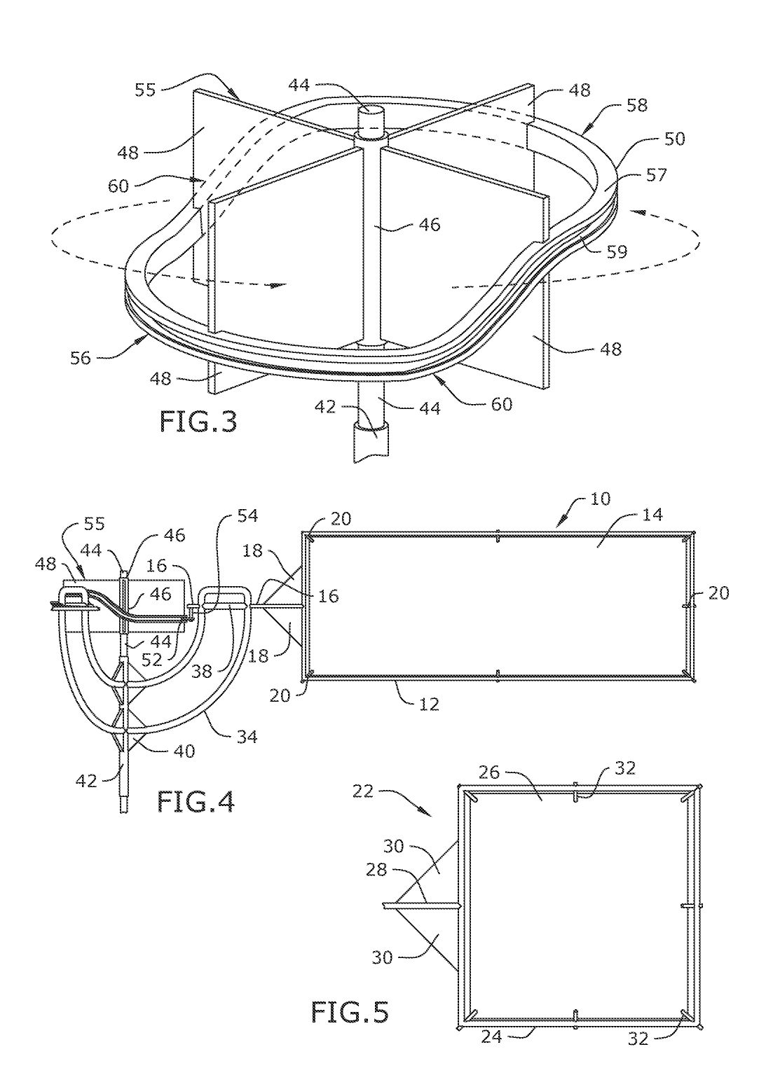

Referring now to FIG. 3, the cam assembly 55 is shown in detail according to an exemplary embodiment of the subject technology. It may be appreciated that features of the cam assembly 55 position the power sails 10 (FIG. 1) into optimum position with minimal resistance to fluid flow. The track system 50 may be round. In the embodiment shown, the track system 50 includes a rail 57 with a substantially elliptical path and a groove 59 along the outer perimeter for receipt of the cam bearing 52. In an exemplary embodiment, the cam bearing 52 is a cam wheel. One or more brackets 48 may couple the rail to the cam tube 46. The rail 57 may include a lower rail section 56, an upper rail section 58, and sloped transition section(s) 60 connecting the lower section 56 to the upper section 58.

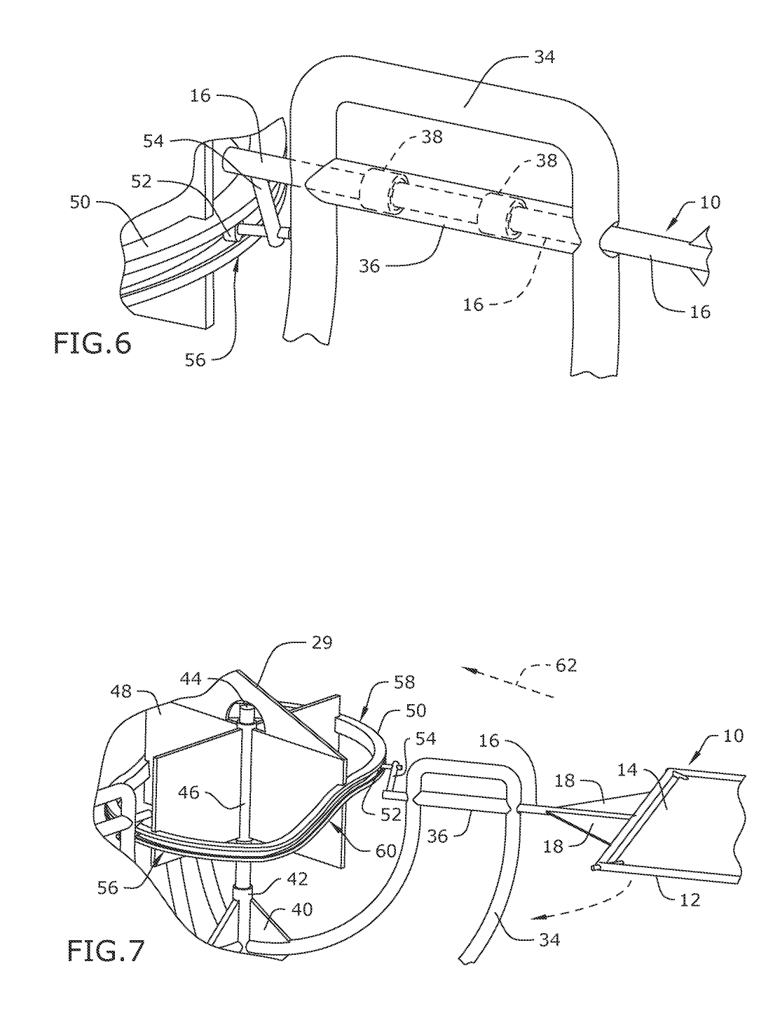

Referring to FIGS. 4 and 6, connection of the power sail assembly 10 to the cam assembly 55 is shown in detail. The power sail assembly 10 may include flexible cords 20 coupling the panel 14 to the frame 12. The arm 16 may couple to the cam assembly through a support bracket inner tube 36 that may connect the lower and upper shafts of the bracket 34. In some embodiments, a rotatable lever 54 may connect the arm 16 to the cam bearing 52. In response to the power sail assembly 10 catching wind, the arm 16 may rotate longitudinally within the inner tube 36 with the aid of roller bearings 38.

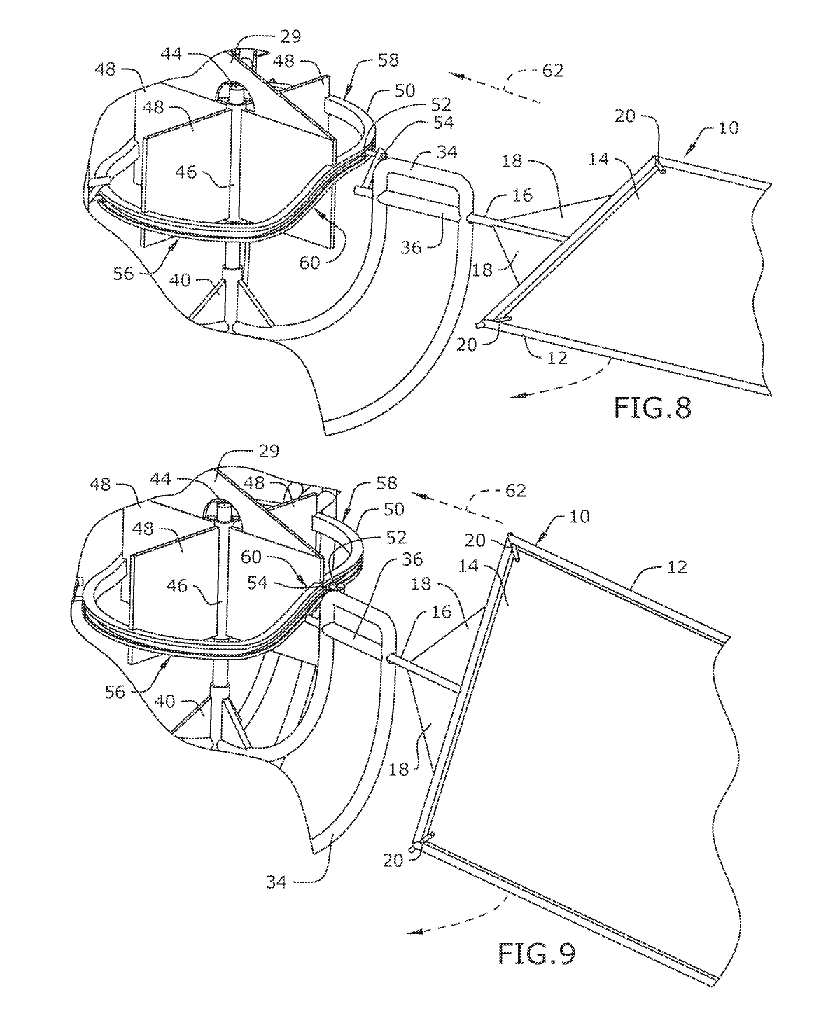

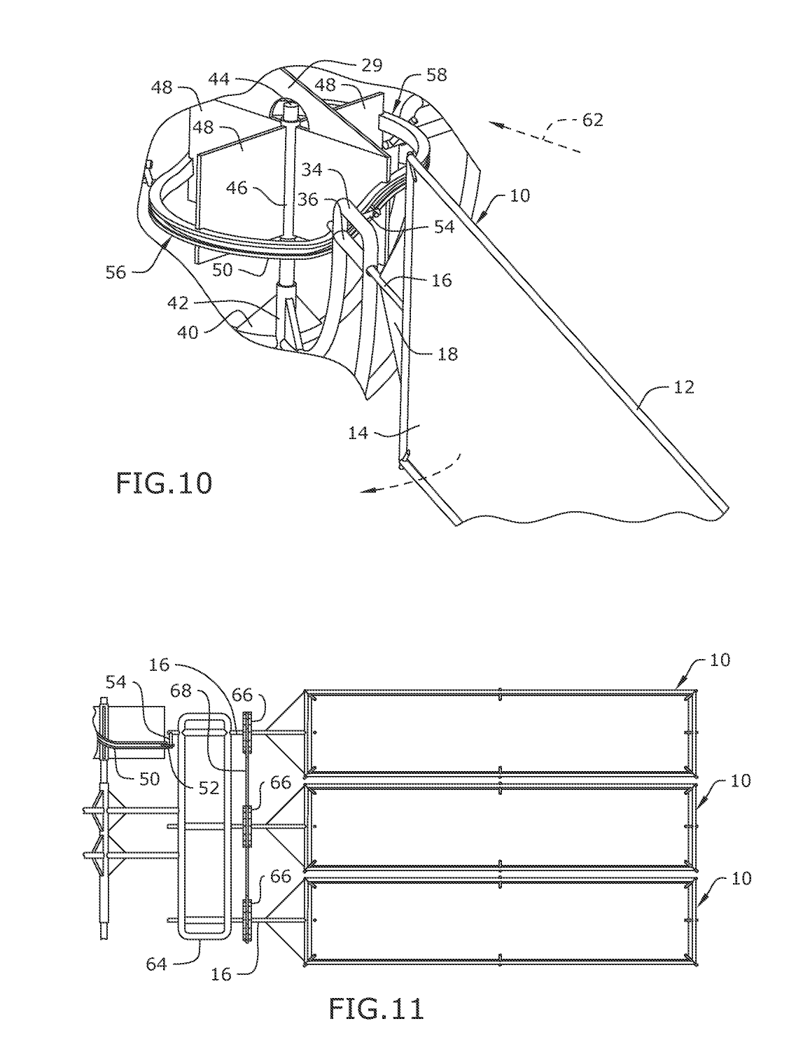

Referring now to FIGS. 7-10 (concurrently with FIG. 2), the tilt angle of the power sail assembly 10 relative to the position of the cam wheel 52 is shown under various conditions. In an exemplary embodiment, the power sail assembly 10 may rotate between a predetermine range of rotation (for example, between 0 degrees (parallel to gravity) to 90 degrees (perpendicular to gravity)). In operation, the vane sail assembly 22 is configured to catch fluid flow and move the cam wheel 52 along the groove in the rail. The cam bracket 48 rotates the track system 50 by the push or pull action of the wind vane assembly 22. The cam bearing (s) 52 rise and fall within the cam track rail groove with the rotation of the cam track system 50. As the cam bearing(s) 52 ascend, descend or remain on one plane (for example, within the lower section 56 or upper section 58), the panel(s) 14 may be lifted into or out of fluid flow causing the sail assembly(s) 10 to tilt and rotate the arm 16 and lever 54. The sail(s) 10 that catch wind help turn the bracket(s) 34 and in turn the rotor tube 42 with full force. As a sail 10 falls out of fluid flow, the sail 10 rotates parallel to gravity removing resistance from the system.

Referring now to FIG. 11, an embodiment using multiple sail assemblies 10 mounted to one bracket 34 is shown according to another exemplary embodiment. It will be understood that the embodiment shown operates similar to the embodiment described in FIGS. 1-10 except that it may include a support bracket 64 instead of the bracket 34 and a chain 68 rotates via sprockets 66, shafts connecting the sail assemblies 10 to the cam assembly.

Persons of ordinary skill in the art may appreciate that numerous design configurations may be possible to enjoy the functional benefits of the inventive systems. Thus, given the wide variety of configurations and arrangements of embodiments of the present invention the scope of the present invention is reflected by the breadth of the claims below rather than narrowed by the embodiments described above.

What is claimed is:

1. A wind turbine, comprising:
a turbine shaft;
a cam bearing track positioned radially around the turbine shaft, the track including a lower section, an upper section, and a sloped section connecting the lower section to the upper section;
a groove along an outer perimeter of the track;
a cam bearing configured to move within the groove;
an arm coupled to the cam bearing, the arm projecting axially away from the turbine shaft; and
a sail coupled to the arm.

2. The wind turbine of claim 1, further comprising a vane coupled to the cam bearing and configured to align the cam bearing within the groove in response to a direction of fluid flow.

3. The wind turbine of claim 2, wherein the sail is disposed to catch fluid flow in response to the alignment of the cam bearing by the vane.

4. The wind turbine of claim 1, wherein the arm is configured to rotate about a longitudinal axis of the arm in response to the sail catching fluid flow.

5. The wind turbine of claim 1, wherein the cam bearing is a wheel cam.

6. The wind turbine of claim 1, wherein the wind turbine is a vertical axis wind turbine.

7. The wind turbine of claim 6, wherein the wind turbine is a Savonius type wind turbine.

8. The wind turbine of claim 1, further comprising a panel of the vane, configured to rotate into a position perpendicular to gravity in response to being in fluid flow.

9. The wind turbine of claim 8, wherein the panel is configured to rotate into a position parallel to gravity in response to being out of fluid flow.

10. The wind turbine of claim 1, further comprising a lever connected between the cam bearing and the arm, the lever configured to turn the sail within a predetermined range of rotation.
